(19) United States
(12) Patent Application Publication
(10) Pub. No.: US 2005/0002515 A1
(43) Pub. Date: Jan. 6, 2005

(54) Dialing techniques for a contact center

(76) Inventors: Brian E. Mewhinney, Carmel, IN (US); James Purciful, Westfield, IN (US); Sanjit Patel, Indianapolis, IN (US)

Correspondence Address: Woodard, Emhardt, Moriarty, McNett & Henry LLP;Bank One Center/Tower, Suite 3700, 111 Monument Circle, Indianapolis, IN, 46204-5137, US

(21) Appl. No.: 10/837,892

(22) Filed: May 3, 2004

Related U.S. Application Data
(63) Continuation-in-part of application No. 09/616,083, filed on Jul. 13, 2000, now Pat. No. 6,804,346.
(60) Provisional application No. 60/467,543, filed on May 2, 2003.
(60) Provisional application No. 60/143,460, filed on Jul. 13, 1999.
(60) Provisional application No. 60/186,487, filed on Mar. 2, 2000.

(51) Int. Cl. H04M 3/00; H04M 5/00

(52) U.S. Cl. 379/266.08

(57) ABSTRACT

The present invention includes one or more devices encoded with logic to configure a predictive outbound contact campaign when executed with one or more servers. Such logic is effective to selectively include pre-contact policies, contact analysis policies, and/or post-contact analysis policies, that are each executed on a contact-by-contact basis. Each of these policy types includes one or more conditions that are evaluated to select between at least two different behaviors or actions.

### CROSS-REFERENCE TO RELATED APPLICATIONS

The present application claims the benefit of U.S. Provisional Patent Application No. 60/467,543 filed on 2 May 2003 and is a continuation-in-part of U.S. patent application Ser. No. 09/616,083 filed on 13 Jul. 2000, which claims the benefit of U.S. Provisional Patent Application No. 60/143,460 filed on 13 Jul. 1999 and U.S. Provisional Patent Application No. 60/186,487 filed on 2 Mar. 2000, each of which is hereby incorporated by reference in its entirety, as if fully set forth herein.

### BACKGROUND

This invention relates generally to communication systems, and more particularly to telephonic communication systems with a “predictive dialing” capability.

In a contact or call center, an agent typically communicates with contacts through in-bound calls, out-bound calls, or both. This communication is often by voice using a telephone handset or headset component of the agent's workstation. Usually, the workstation also includes a computer terminal or personal computer to interface with various application modules. These modules provide the agent information directed to the particular transaction involved.

The time it takes agents to handle calls and the lapse of time between calls are factors that influence the efficiency of call center operations. To improve contact efficiency, outbound calls from a contact center are sometimes initially established through use of an automatic dialing capability. Although sometimes at odds with efficiency goals, it is also generally desirable to provide as favorable an impression as possible with regard to call/contact center communications. To manage such competing interests, there is a continuing demand for further contributions in this technology arena.

### SUMMARY

One embodiment of the present invention includes a unique communication technique. Other embodiments include unique communication methods, systems, devices, and/or apparatus.

Further embodiments, features, objects, forms, benefits, advantages, and other inventive aspects of the present application will become apparent from the description and figures provided herewith.

### BRIEF DESCRIPTION OF THE DRAWINGS

FIG. 1 is a schematic view of a contact system.

FIG. 2 is a functional block diagram of a communication server and an agent terminal.

FIGS. 3A-3B is a flowchart of an exemplary incoming call.

FIG. 4 is a flowchart of an exemplary outgoing call.

FIG. 5 is a schematic view of a contact system distributed over multiple sites remotely located relative to one another.

FIG. 6 is a diagrammatic view of predictive outbound contact logic that can be implemented with the system of FIG. 1 or FIG. 5.

FIG. 7 is a diagrammatic view of selected aspects of configuration logic for the predictive outbound contact logic of FIG. 6.

FIG. 8 is a flowchart of one procedure involving different types of contact level policies that can be implemented with the system of FIG. 1 or FIG. 5.

FIG. 9 is a flowchart of one procedure for responding to different analysis results for a call placed with a predictive dialer.

FIGS. 10-14 are nonlimiting examples of Graphical User Interface (GUI) displays relating to selected aspects of workflow and campaign configuration.

FIGS. 15-20 are nonlimiting examples of GUI displays relating to selected statistics for predictive outbound contact techniques.

### DETAILED DESCRIPTION OF SELECTED EMBODIMENTS

For the purpose of promoting an understanding of the principles of the invention, reference will now be made to the embodiments illustrated in the drawings, and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

In the example embodiment to be discussed in the following paragraphs, a call center accepts inbound and makes outbound telephone calls to and from customers and prospects (collectively “customers” herein) for an organization. The call center is equipped with both automatic call-handling equipment (an interactive voice response (IVR) system, voicemail system, and fax-back system) and live agents. A portion of the call center operation involves outbound calling of prospective customers, or customers whose accounts are overdue, for example. This function uses a predictive dialing unit to automatically attempt to dial and reach these persons with minimal (if any) involvement by a live person. When deciding whether or when to attempt to place one or more additional outbound calls, the predictive dialing unit takes into account the substantive status of calls already in progress.

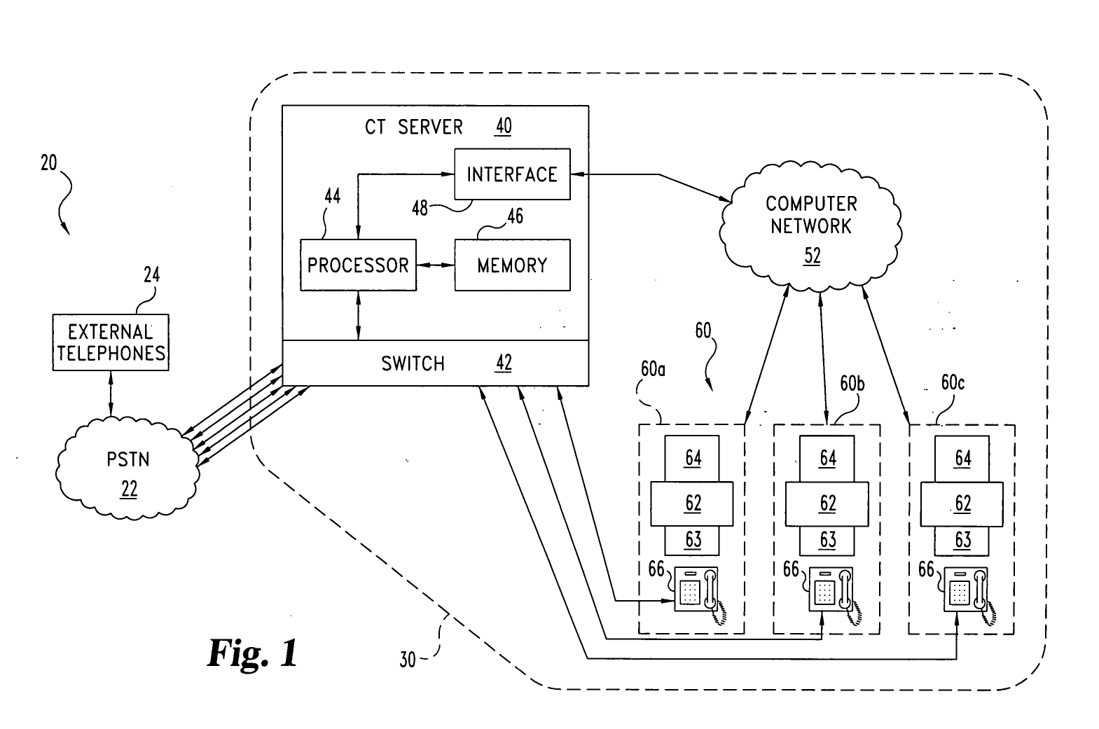

FIG. 1 schematically illustrates call center system 20 of one embodiment of the present invention. System 20 includes Public Switched Telephone Network (PSTN) 22 operatively coupled to a number of external telephones 24 and call center 30. Call center 30 includes Computer Telephony (CT) server 40 with telecommunications switch 42 coupled to PSTN 22 via lines 32. Server 40 also includes processor 44, memory 46, and network interface 48. Network interface 48 is operatively coupled to computer network 52. It should be understood that server 40 may include more than one processor or CPU and more than one type of memory; where memory 46 is representative of one or more types. Furthermore, it should be understood that while one server 40 is illustrated, more servers may be utilized in alternative embodiments. Processor 44 may be comprised of one or more components configured as a single unit. Alternatively, when of a multi-component form, processor 44 may have one or more components located remotely relative to the others. One or more components of processor 44 may be of the electronic variety defining digital circuitry, analog circuitry, or both. In one embodiment, processor 44 is of a conventional, integrated circuit microprocessor arrangement, such as one or more PENTIUM-based processors supplied by INTEL Corporation of 2200 Mission College Boulevard, Santa Clara, Calif., 95052, USA. For this embodiment, switch 42 can be in the form of one or more standard telephone communication processing boards, such as those provided by DIALOGIC of 1515 Route Ten, Parsippany, N.J., 07054, USA or ACULAB of Lakeside, Bramley Road, Mount Farm, Milton Keynes, MK1 1PT, United Kingdom; to name just a couple.

Memory 46 may include one or more types of solid-state electronic memory, magnetic memory, or optical memory, just to name a few. By way of nonlimiting example, memory 46 may include solid-state electronic Random Access Memory (RAM), Sequentially Accessible Memory (SAM) (such as the First-In, First-Out (FIFO) variety or the Last-In First-Out (LIFO) variety), Programmable Read Only Memory (PROM), Electrically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, memory 46 may be volatile, nonvolatile, or a hybrid combination of volatile and nonvolatile varieties.

Network 52 may be in the form of a Local Area Network (LAN), a Municipal Area Network (MAN), a Community/Campus Area Network (CAN), a Wide Area Network (WAN), such as the Internet, or other network type as would occur to those skilled in the art. Also coupled to network 52 are a number of agent workstations 60a, 60b, 60c (collectively designated agent stations 60). Agent workstations 60 each include workstation computer 62 coupled to display 64. Each workstation 60 may also include one or more operator input devices 63such as a keyboard, mouse, track ball, light pen, and/or microphone, to name just a few representative examples. Also, besides display 64, one or more other output devices may be included such as loudspeaker(s) and/or a printer.

Each workstation 60 further includes a telephone unit 66 as schematically illustrated in FIG. 1. Telephone units 66 may be in the form of a handset, headset, or other arrangement as would occur to those skilled in the art. Workstations 60 may be arranged identically to one another or may differ from one to the next as would occur to those skilled in the art. In one common arrangement, one workstation 60 is designated for an agent supervisor that has different capabilities than those of other workstations 60. Furthermore, it should be understood that more or fewer workstations 60 may be utilized than those illustrated. Under the control of CT server 40, switch 42 is configured as a predictive dialer (as discussed below), and may also be configured to operate as a Private Branch Exchange (PBX), Automatic Call (or Contact) Distributor (ACD), a combination of these, or another switching configuration as would occur to those skilled in the art. Alternatively or additionally, system 20 may be arranged to provide for the coordination, conversion, and distribution of a number of different forms of communication, such as telephone calls, voicemail, faxes, e-mail, web chats, web-call backs, Short Message Service (SMS) traffic, and the like. Furthermore, business/customer data associated with various communications may be stored in memory 46 and selectively accessed by one or more workstations 60. This data may be presented at the workstation 60 on a corresponding display 64.

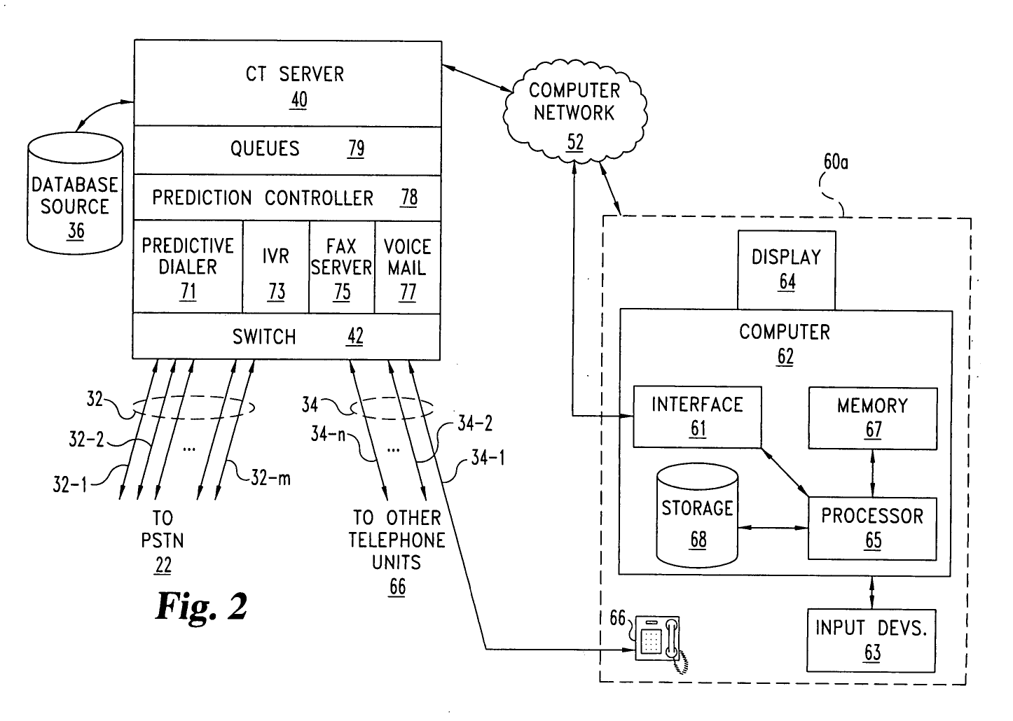

With continuing reference to elements shown in FIG. 1, and also with reference to additional detail shown in FIG. 2, more specific aspects of this embodiment will be discussed. Certain elements shown in FIG. 1 are also shown in FIG. 2 (using common reference numerals), while additional components that are either implemented by, complementary to, or separate from the elements shown in FIG. 1 are given different reference numerals. In the exemplary system shown in FIG. 2, external telephone lines 32-1 to 32-m (collectively designated lines 32) connect PSTN 22 to switch component 42 of CT server 40. Each of lines 32 is capable of carrying incoming or outgoing calls for call center 30. For example, a customer may make an inbound call that is connected to call center 30 via line 32-1. CT server 40 answers the call and controls switch 42 to connect the call to interactive voice response (IVR) unit 73. Information is collected from and/or given to the customer by IVR 73 using methods known in the art. For example, IVR 73 can provide a menuing system responsive to DTMF signals to provide a customer with current account information. In addition, one or more databases (such as database source 36) may be consulted to obtain part or all of that information.

If the customer requests a facsimile transmission of, for example, a specification sheet or account status confirmation, CT server 40 provides the necessary information to fax server component 75, which sends the requested facsimile transmission using, for example, line 32-2. In other circumstances, CT server 40 may allow a customer to leave a voicemail message using voicemail component 77. If the customer has difficulty navigating the system, or has an inquiry or request that cannot be handled by automated means, CT server 40 connects the customer with an agent by using switch 42 to link the incoming line 32-1 with a selected internal telephone line from internal lines 34 (individually designated 34-1, 34-2, . . . 34-n). An available agent at workstation 60a receives the call on telephone unit 66 and assists the customer. A call that connects an agent and a caller is referred to herein as an “active call.” “Substantive progress” of an active call refers to the state, among a plurality of states, of the discussion between the parties to the call, as determined with reference to the content of the discussion.

Close to the time that the customer's call is routed to workstation 60a (and preferably before it is so routed), information related to the customer (such as an account number, name, calling history, account status, etc.) is read from database source 36 and provided to the agent by CT server 40 or other source (such as a database in memory 46 or elsewhere). As the call progresses, the agent and the customer may discuss basic account information, current contact information for the account, additional services that may be provided, expansion of a line of credit, and other matters requiring more or less of the agent's time.

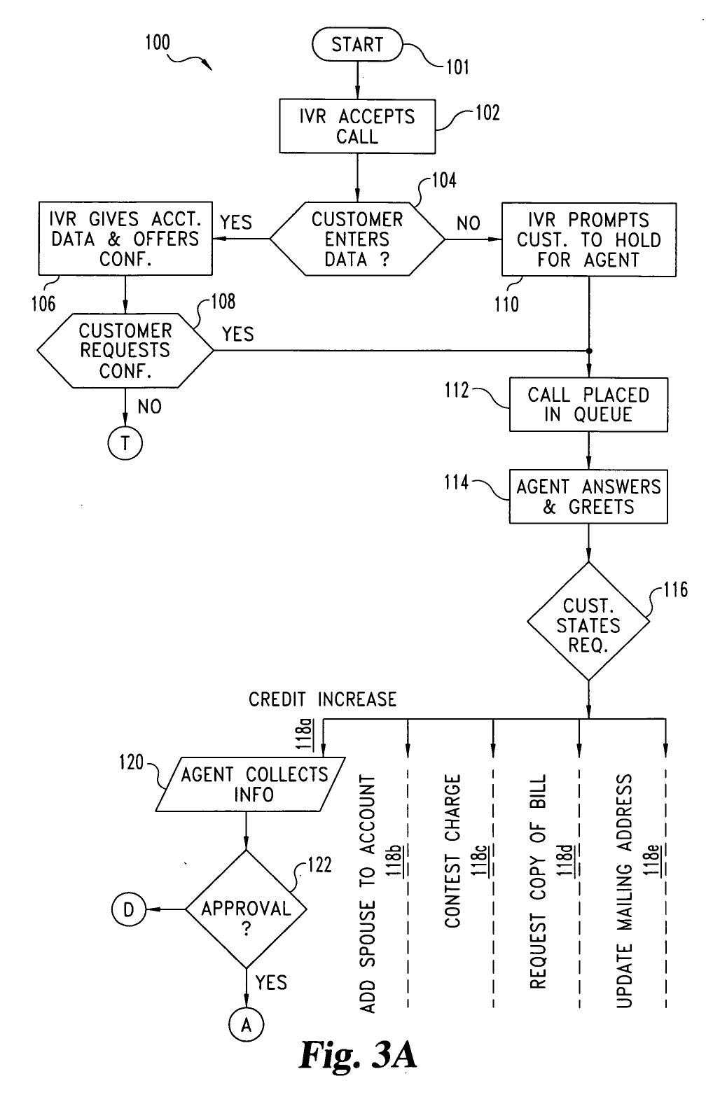

The flow of one such exemplary call is shown in process 100 contained in FIGS. 3A and 3B. This exemplary call begins at start point 101. The IVR system accepts the call at block 102 and requests the entry of an account number by the customer. IVR unit 73 determines at decision block 104 whether the customer has entered a valid account number. If so, the IVR unit 73 gives the customer account data and offers the opportunity to speak with a customer service representative at block 106. IVR 73 then determines at block 108 whether the customer has accepted that offer. If not, the process proceeds to point T (discussed below) to terminate the call. If the customer is determined at decision block 104 not to have entered valid account data, then the IVR unit 73 prompts the customer at block 110 to hold for a live agent. At that point, or if the customer is determined at decision block 108 to have requested a conference with an agent, the call is placed in a holding queue at block 112. When an agent becomes available, the call is connected to the agent (for example, via line 34-3), and the agent answers and greets the customer at block 114, then asks for the customer's request.

The customer states his or her request at decision block 116, and an appropriate branch is taken based on that request. As an example, if the customer requests a credit increase, path 118a is taken. (Though only branch 118a will be discussed herein in further detail, processes to be followed in response to other customer requests can easily be determined by those skilled in the art.) If the customer asks to add the name of a spouse to an account, path 118b is followed. If the customer wishes to contest a charge to his account, the path marked 118c is followed; and if the customer requests an additional copy of a bill, then path 118d is followed. Alternatively, if the customer requests to update the mailing address on his account, the path denoted 118e is followed. Other procedures (paths) may be established for other requests, depending on the operational needs of a given call center.

The process of branch 118a will now be described in further detail. The agent collects additional information necessary to evaluate the credit increase request at information block 120. The decision is made whether to approve the increase at decision block 122. If an approval is granted, the process continues at point A (see FIG. 3B); and if it is denied, the process continues at point D (see FIG. 3B).

Turning to FIG. 3B, we resume at point D. The agent notifies the customer of the denial at block 124, but offers alternative services at block 126, explaining the various features of the alternative offerings. The customer decides at block 128 whether he is interested in the alternative services. If not, the method proceeds to closing at point C, described below. If, however, the customer is interested in the additional services (as determined at decision block 128), the agent answers any additional questions about those additional services that the customer might have (block 130).

If, on the other hand, credit is approved at decision block 122, the process proceeds into FIG. 3B at point A, and the agent notifies the customer of the approval at block 132. The agent offers additional services at block 134. Again, the customer determines whether he or she is interested in the additional services at decision block 136. If not, the process proceeds to closing at point C (described below). If, however, the customer is interested in the additional services (as determined at decision block 136), the agent answers questions regarding the additional services at block 130. The customer determines at decision block 138 whether to order the additional services. If the customer does order the services, the agent takes any new information necessary to complete the order at block 140; the process then resumes with an offer of still additional services at block 134. If the customer decides at decision block 138 not to order additional services, or if a closing was indicated at decision block 128 or decision block 136, the agent thanks the customer for the call at block 142. The system then terminates the connection and opens lines 32-1 and 34-3 for new calls at block 144. The process ends at block 146.

It can be seen from the above example that, depending on the preferences and needs of the customer, the length of calls can vary dramatically. For example, many calls may terminate by a negative decision at block 108, but some calls will proceed through offers, questioning phases, and additional purchases during repeated passes through blocks 134, 130, and 140, respectively.

It was discussed above that one aspect of the operation of call center 30 is outbound calling. Generally, predictive dialing unit 71 of CT server 40 obtains telephone numbers and other relevant data for customers to be called from data source 36. Predictive dialer 71 places calls via one or more of outside lines 32 using the calling information. If an appropriate individual is reached on a call, the call is preferably transferred to telephone unit 66 of an available agent using one of internal lines 34. If no agents are immediately available, preliminary processing may be done such as playing a prerecorded announcement or greeting, or collecting account information from the customer) using IVR-type functions of CT server 40 while the call is placed in a queue through queuing unit 79 to wait for an agent to become available. One aspect of the present invention relates to prediction controller 78, which triggers predictive dialer 71 to make such calling attempts as discussed herein.

In the present exemplary embodiment, after an outbound call is transferred to telephone unit 66 of a workstation 60 that is staffed by an available agent, the agent follows a telemarketing script in order to inform the customer or prospective customer about the offer and to entice the customer or prospective customer to purchase certain goods or services. These scripts are displayed on display unit 64, preferably using individualized data that CT server 40 forwards to the workstation 60a by way of computer network 52 and interface device 61. The scripts are preferably stored at workstation 60a in storage unit 68, then retrieved as needed by processor 65. Processor 65 also executes programming instructions from storage 68 and/or memory 67 that enable processor 65 to control the operations of computer 62, including managing interface device 61, providing output on display 64, and accepting input via input devices 63.

As the agent presents the scripted material, the agent scrolls through pages of text on display 64 using input devices 63, and navigates a decision tree based on the customer/prospect's responses to the presentation.

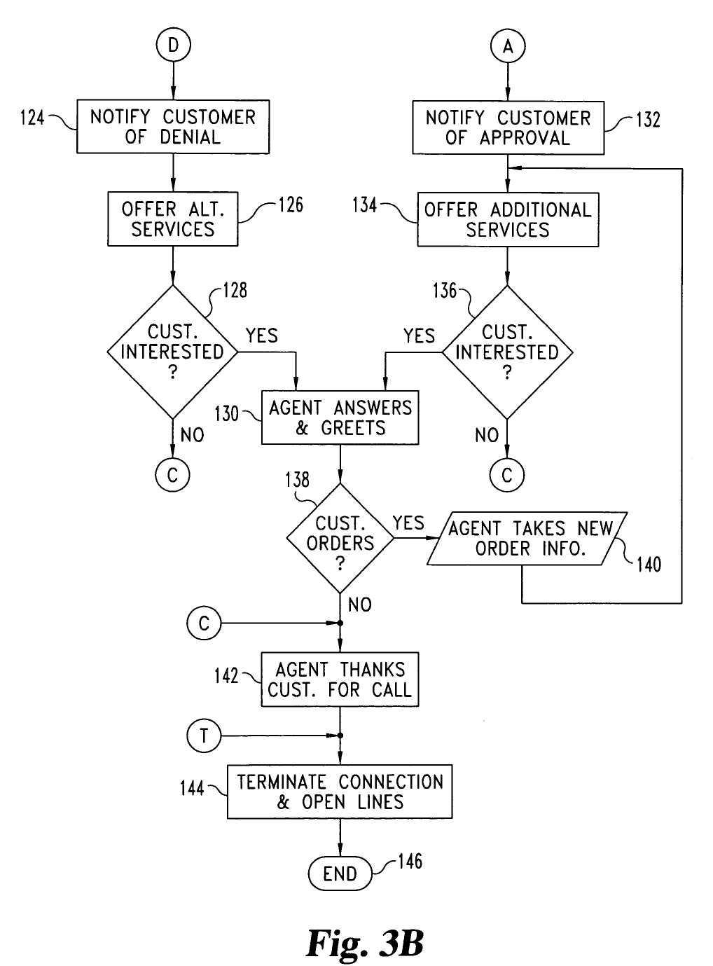

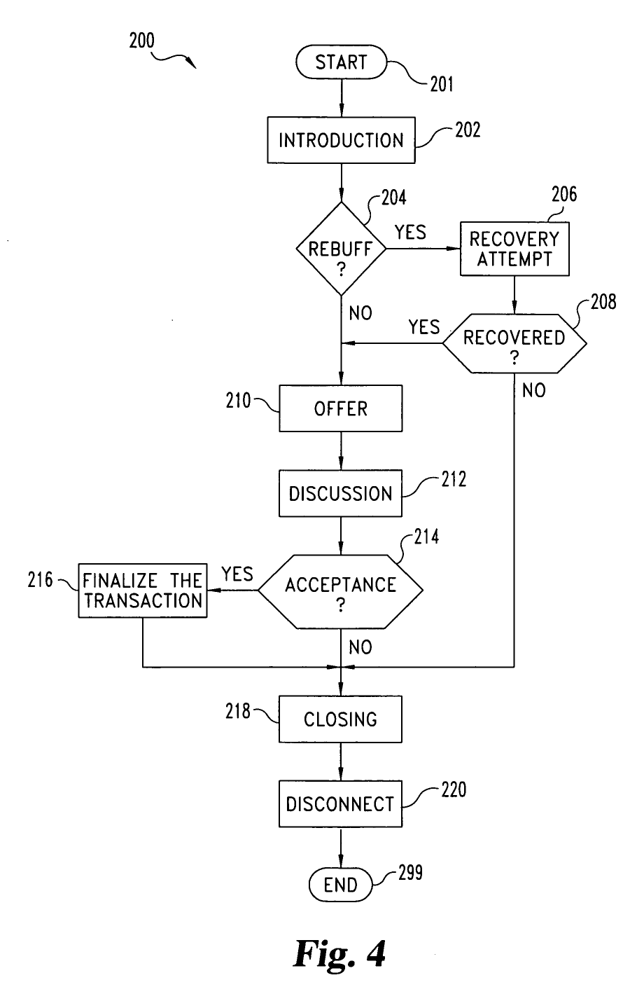

An overview of the stages of an exemplary outbound telemarketing call is provided in, and will now be discussed with reference to, process 200 in FIG. 4. The process for each connected call begins at start block 201. The agent introduces the call at block 202 by identifying himself and the company on whose behalf the call is being made. If the individual being called rebuffs the attempted contact (decision block 204), the agent attempts to “recover” the contact by insisting on the beneficial nature of the call and by highlighting the benefits (block 206). If the recovery attempt is successful (decision block 208), or if this prospect did not rebuff the initial introduction at decision block 204, the offer is given at block 210. The agent then discusses the details of the offer and answers the prospect's questions about the offer at block 212, and the prospect decides (decision block 214) whether to accept the offer. If the offer is accepted at decision block 214, the transaction is finalized at block 216 by the taking of any additional, necessary information to complete the transaction. When the transaction is complete, or if the prospect decides (at block 214) not to accept the offer, or if the initial recovery attempt fails (at block 208), final information and a parting greeting are provided to the prospect at block 218 (for example, return contact information, and an expression of appreciation for considering the offer). At this time the call is terminated at block 220, and the lines (32-1 and 34-3 in this example) are disconnected. The telemarketing process as to that prospect then ends at end block 299.

At each stage of a call according to exemplary process 200, the agent is provided with scripted text intended to facilitate a successful presentation of the offer. During each phase, different text is available to the agent on display 64. In some circumstances, this command reflects data, a decision, or information provided by the customer. When the agent completes presentation of the material from one display and is ready to proceed with material from another, the agent issues a command using one or more of input devices 63, and computer 62 produces the next display of material to be presented. In some circumstances, this command reflects data, a decision, or information provided by the customer. In other circumstances, the command may reflect a decision by the agent, or simply the completion of the presentation of a screen-full of text. When the presentation moves from one stage to another (for example, from an offer stage at block 210 to a discussion stage at block 212), processor 65 sends a signal to prediction controller 78 of CT server 40 by way of interface device 61 and computer network 52.

Prediction controller 78 accepts the signal from computer 62 at workstation 60a, and accepts similar signals from other workstations 60. Prediction controller 78 also monitors queues 79, IVR system 73, and voicemail system 77 of CT server 40, and uses feedback from each subsystem to optimize the outbound dialing through predictive dialer 71. For example, if a call is in block 106 of FIG. 3A (wherein IVR 73 is providing account information to the user), there is some likelihood that the caller will require the assistance of an agent, but the likelihood is greater when the call is at block 104. Prediction controller 78, therefore, will tend to signal predictive dialer 71 to dial a new outbound call more frequently when an inbound call is at block 106 than when an inbound call is at block 102 in the process shown in FIG. 3A.

Similarly, one might find empirically that the caller on a call at block 126 (in FIG. 3B), who has just been denied credit, is far less likely to purchase suggested add on services than a customer who has just been approved for additional credit (at block 134 of FIG. 3b). Prediction controller 78 would, therefore, be more likely to trigger a new dialing attempt when an inbound call is at block 126 than when the inbound call is at block 134.

The remaining time during which an agent will be on an outbound call can also be more accurately predicted by considering the substantive phase of the call. Consider two outbound calls, which will be discussed with continuing reference to FIG. 4. In the first call, after the agent's introduction (block 202), the called party immediately reports a lack of interest in speaking with the agent (an affirmative result at decision block 204). The agent attempts to recover the prospect at block 206, but the prospect is not persuaded to listen further (a negative result at decision block 208). As the agent thanks the prospect for taking the call (at block 218), the call is almost sure to end within seconds. In a system according to the present invention, the system can take into account the substantive posture of the call at each of these points and decide accordingly whether to begin to dial another prospect.

In a second exemplary call, after the agent's introduction (at block 202), the prospect expresses an interest in hearing the agent's offer (negative result at decision block 204). The agent explains the offer at block 210, and a discussion of the merits and details of the proposal ensues at block 212. Although the same amount of time may have elapsed in this second call as it took the first call to reach closing block 218, the second call is likely to remain connected for a substantial amount of time as the agent and the prospect discuss the offer and, if the prospect accepts, exchange information to complete the transaction. In a system according to this embodiment of the present invention, prediction controller 78 is notified that the agent and prospect are in the discussion phase of the call (block 212) and determines to wait further before attempting to connect a new call to replace the current call. This provides a great advantage over many prior art systems that do not take into account the substantive phase of the call.

In another form of the present invention, the agent uses any suitable input method (such as one or more input devices 63) explicitly to indicate to CT server 40 the substantive progress of the call. Software executed by processor 65 interprets the input and communicates the substantive progress via network 52 to CT server 40. In one embodiment of this form, the agent presses a particular key on a keyboard input device 63 to make that report. In another embodiment, the agent selects one out of a plurality of on-screen icons to make that report.

In yet another form of the present invention, the agent issues commands with input device(s) 63 to navigate prompts presented by computer 62 on display 64. Software executed by processor 65 interprets these navigational commands and, at various points in the script, reports the progress of the call to CT server 40.

In still another form, the prediction controller 78 not only takes into account the last phase of the call reported by the agent, but also the amount of time that has passed since that reporting. Alternatively, prediction controller 78 also operates as a function of a global “aggressiveness” setting that applies to an entire calling campaign, and/or the prediction controller 78 also operates as a function of one or more dynamic properties (e.g., length, age of oldest call, average age of calls, etc.) of the one or more queues.

In yet another embodiment, the system maintains statistics (e.g., average and standard deviation) for each agent that reflect the amount of time (“duration”) that the agent spends in a particular call stage. Prediction controller 78 then uses these statistics to determine whether and when to attempt to dial another outbound call. In some of these embodiments, prediction controller 78 also uses collective statistics for all agents in a campaign.

In still other embodiments, instead of (or in addition to) communications being routed through internal lines 34, the communications are routed through network 52 and processed by workstations 60. If the communications are (wholly or partially) in audio form, they may be processed by a sound card or other audio input/output device associated with each workstation 60.

In some embodiments of the present invention, prediction controller 78 is implemented as a software module within the programming for predictive dialer 71. Alternatively or additionally, prediction controller 78, predictive dialer 71, and/or the software that controls workstations 60 can be implemented in one or more modules that can be used in programs written in various languages on various platforms. These can include, for example, programming languages and environments such as Visual Basic, COM (Common Object Model), JAVA, or an application-specific programming or scripting language (such as for a customer relationship management application).

In yet other embodiments, the administrator of system 20 defines call stages that are of interest. Computer 62 at each agent's workstation 60 sends a signal to CT server 40 as the agent enters and/or exits each stage of each active call. In a variation on these embodiments, such progress signals are generated at the entrance/exit of only selected stages.

With respect to predictive contact activities, system 20 can be arranged to define one or more workflows each having one or more associated contact campaigns. As used herein, “campaign” refers to a collection of properties that define how to process a list of prospective contacts. In one example, these properties are used to direct operation of prediction controller 78 and predictive dialer 71 of a server 40 to perform predictive dialing to reach a list of individuals by telephone (see FIG. 2 and accompanying text). In other examples, a campaign may direct predictive establishment of communication with one or more other contact types as an addition or alternative to telephone calls. These other contact types include, but are not limited to, communication by facsimile machine, voice recording machine (such as voicemail and answering machines), email, Short Message Service (SMS), web-call, and/or web-chat.

As used herein, “workflow” refers to properties that direct operation of one or more associated campaigns. For example, these properties can direct when to start and stop associated campaigns and how to run any associated campaigns. Additionally or alternatively, workflow properties may include default campaign properties, a list of participating agents, participating ACD workgroups, participating telephone lines, and the like. The operating logic of server 40 can be arranged to implement a campaign or workflow. Such logic can be completely or partially embodied in predictive dialer 71 and prediction controller 78 of server 40 (see FIG. 2). As used herein, “logic” associated with a device, system, apparatus, processor, server, other equipment, and/or machine-executed operation can be in the form of software, firmware, other programming instructions or code; one or more encoded memory device(s), dedicated hardware (including, but not limited to a synchronous state machine or asynchronous configuration), one or more encoded signals being carried or transmitted on one or more media and/or communication pathways, or a combination of these.

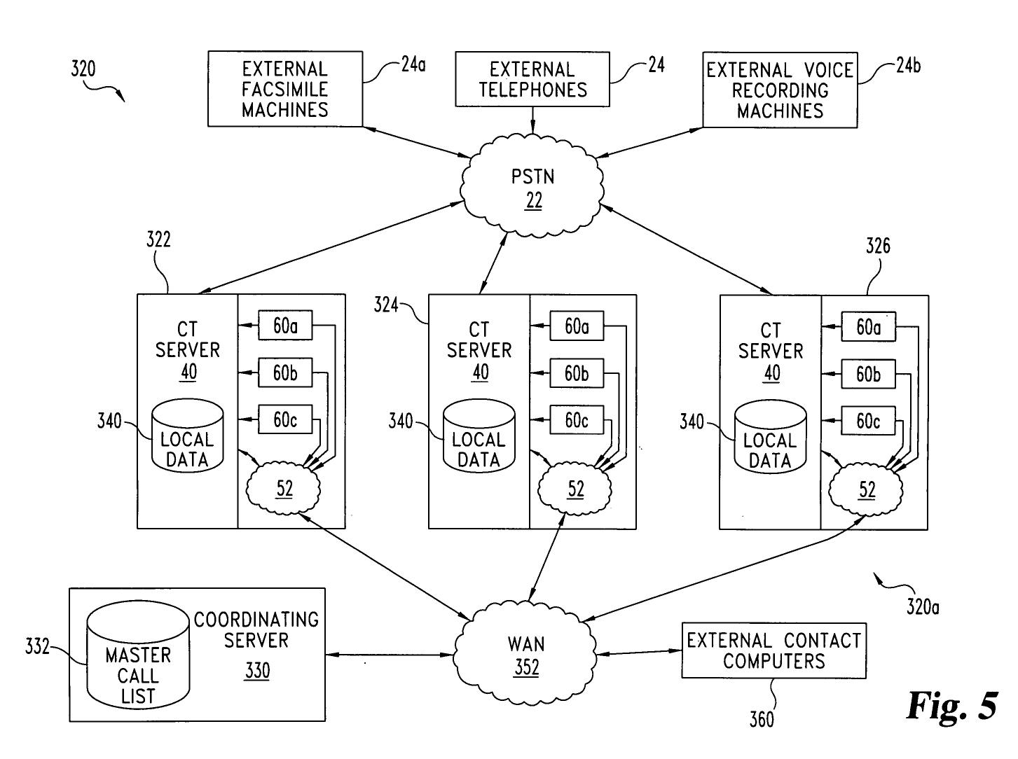

In certain embodiments, a campaign, and/or a workflow and any associated campaigns, can be implemented across multiple servers. For such implementations, two or more of the servers can be included in different call centers that are remotely located relative to one another. FIG. 5 illustrates one such embodiment as contact system 320; where like reference numerals refer to like features. Contact system 320 is configured to provide multisite server arrangement 320a that includes contact centers 322, 324, and 326. Contact centers 322, 324, and 326 are remotely located relative to one another and each include CT server 40 as previously described in connection with system 20 and a number of workstations (specifically designated by reference numerals 60a, 60b, and 60c). It should be appreciated that fewer or typically more workstations can be included at any of contact centers 322, 324, and/or 326. For each contact center 322, 324, 326; server 40 and workstations 60a, 60b, and 60c are coupled to computer network 52 and are otherwise operatively connected in the manner described in connection with FIGS. 1 and 2. Each server 40 is coupled to PSTN 22 via a telephonic switch 42 (not shown) in the manner previously described in connection with system 20 and FIGS. 1 and 2. PSTN 22 is coupled to a number of external devices utilized by potential contacts, including external telephones 24, external facsimile machines 24a, and external voice recording machines 24b, as illustrated in FIG. 5. While three contact centers 322, 324, 326 and corresponding servers 40 are shown, it should be understood that more or fewer contact centers and/or servers 40 could be utilized; and alternatively or additionally, one or more contact centers could include more than one server 40.

Networks 52 are also operatively connected to coordinating server 330 via Wide Area computer Network (WAN) 352. External contact computers 360 are also coupled to WAN 352. It should be appreciated that WAN 352 can and typically does include the internet. Furthermore, any of networks 52 can be included as part of WAN 352. Indeed, alternatively, networks 52 and WAN 352 can be represented as a single network. In one nonlimiting embodiment, each network 52 is of a LAN variety for the corresponding contact center that is coupled via a firewall to an internet form of WAN 352. Alternatively or additionally, WAN 352 can include a dedicated wide area network connection between any of networks 52 and server 330.

Server 330 can be configured in the same manner as any of servers 40 with the addition of certain operating logic and data to coordinate predictive dialing or other contact activities distributed across all the servers of multisite server arrangement 320a. Server 330 can be included at any of contact centers 322, 324, or 326; or can be remotely located at a different site and/or contact center. In one form, server 330 includes a master call list and other configuration information stored in one or more memory devices 332. Devices 332 can be of any of the types or combinations described in connection with system 20 and/or can include one or more remotely connected mass storage devices typically used to store database information.

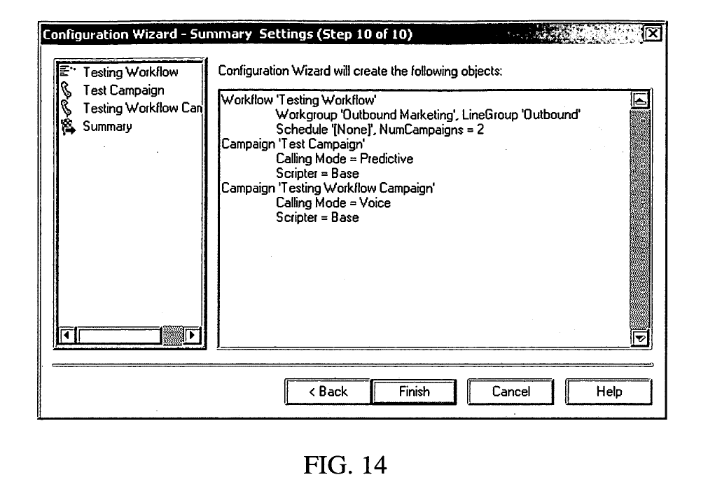

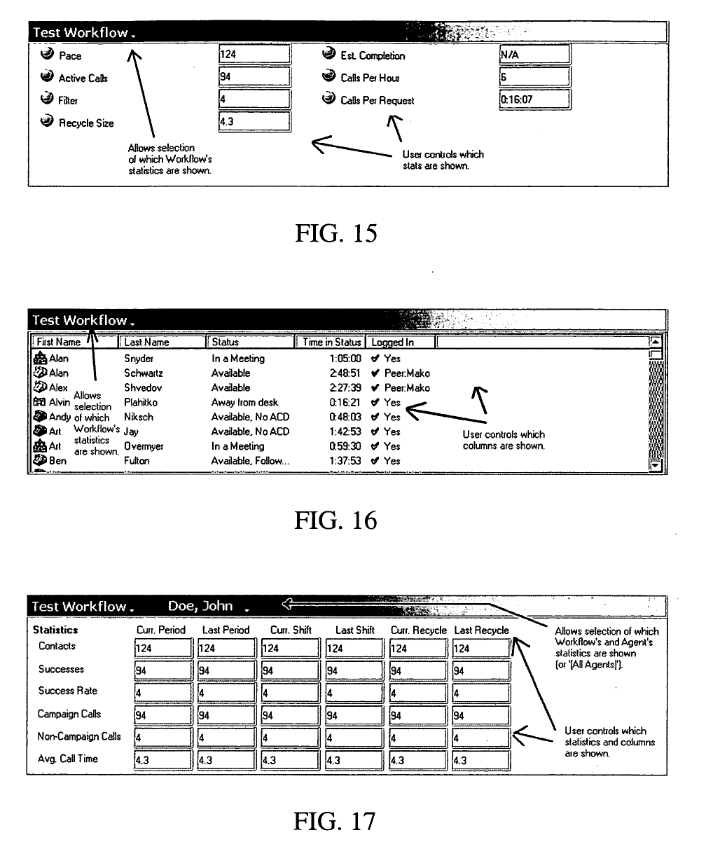

In one embodiment, the master list and configuration information stored in the one or more memory devices 332 is utilized by server 330 to centralize, control, and coordinate multisite execution of a workflow and/or one or more campaigns to predictively dial or otherwise make contact with corresponding list entries. For this form, the operating logic of servers 40 and server 330 also collects statistics corresponding to a workflow and/or campaign being performed across multisite server arrangement 320a. Workflow, campaign, and other pertinent data local to one of contact centers 322, 324, or 326 is correspondingly stored in one or more memory devices 340, which may be included in memory 46 for a given server 40 (see FIGS. 1 and 2). The operating logic of servers 40 and server 330 of this form also facilitate multisite review by an operator with appropriate privileges (such as a supervisor). Specifically, such multisite review provides the operator the capability to review the collected workflow and/or campaign statistics for one of contact centers 322, 324, or 326 from any of servers 40 or server 330. The review of such statistics of one server 40 through another server 40 is provided through server 330. In one form, at least some of these statistics are the same as those described in connection with Tables I-IV and/or FIGS. 15-20 hereinafter.

The supervisor is also able to view the stats from all of the servers rolled up into a summary display showing cumulative data across all collaborating servers 40. Also, these statistics are available from any client workstation.

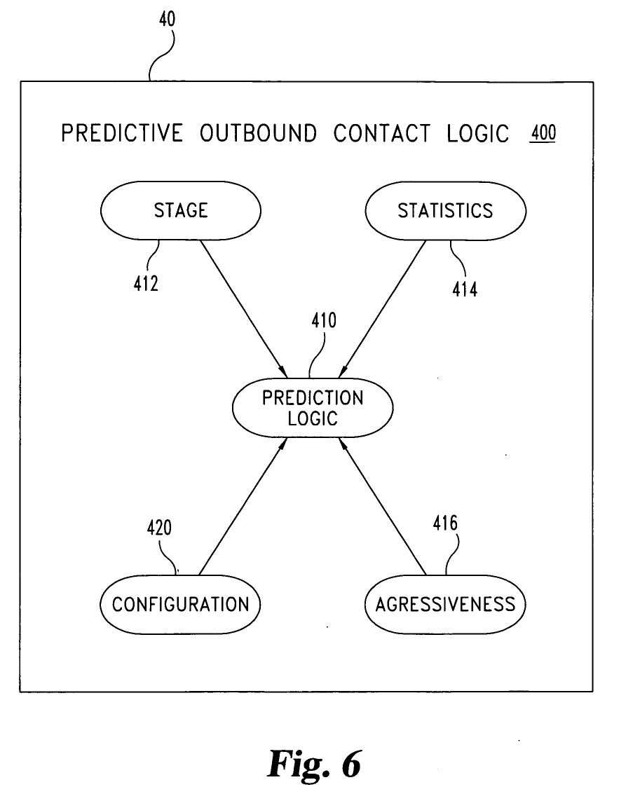

Referring to FIG. 6, one embodiment of predictive outbound contact logic 400 for server 40 is schematically illustrated; where like reference numerals refer to like features. In FIG. 6, selected aspects of logic 400 are specifically designated by reference numerals for ease of further description as follows. Logic 400 is defined for a given predictive contact campaign which may be included in a workflow. Logic 400 can be utilized in a single server environment or across multiple servers as described in connection with multisite server arrangement 320a. Logic 400 includes prediction logic 410 that is executed during operation of a campaign to form predictions as to the appropriate time to initiate each contact placement. Prediction logic 410 is updated/adjusted in accordance with various inputs including stage status input 412, statistical information input 414, an aggressiveness information input 416, and configuration logic 420. In one form, prediction logic 410 is at least partially embodied in predictive dialer 71 and prediction controller 78 described in connection with FIG. 2.

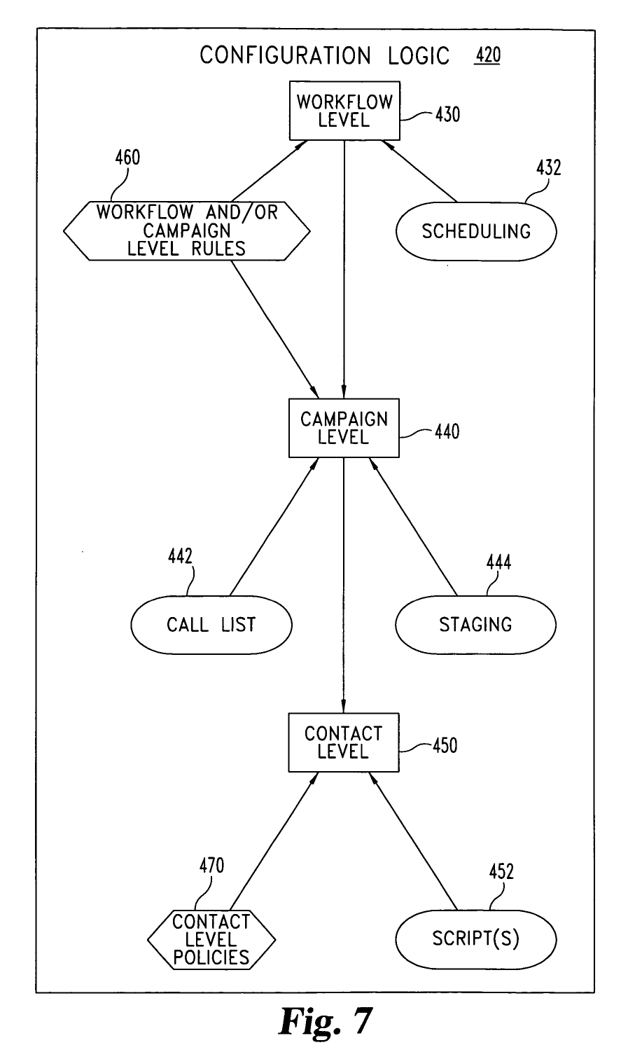

As described in connection with FIG. 4, staging relates to different phases or states of communication between a contact and an agent. Stage status input 412 provides current data about the staging of ongoing contacts that is utilized, at least in part, by logic 410 to make contact placement predictions. In contrast, the particular stage or stages to be monitored and reported through input 412 are defined as part of configuration logic 420 as further described in connection with FIG. 7. The inclusion of staging status input 412 may be absent in other embodiments of the present invention.

Like stage status input 412, statistical information input 414 is also optional. Statistical information input 414 provides current statistical data from various sources as defined by an operator in configuration logic 420. For example, in order to assure a line is available before dialing, and in an effort to reduce the overall load on the system, the dialer process can actively listen for queue statistic(s) that provide the total number of free lines (as well as the total lines) for a specific line group. These statistics can be delivered in intervals and the dialer will be responsible for adjusting the statistic value between the times that the interval updates are received. A controller can provide procedures for setting or retrieving the number of lines available in a line group. The classes responsible for placing calls (call strategy instances) can check with the controller for line availability before sending a notification to begin dialing. If there are no lines available for use then the contact will be queued for later processing.

In another example, the number of calls placed per second is adjusted based on statistical information input 414. While dialing, monitoring occurs to reduce any overloading of the system or causing of a long delay in dial-tone. Alternatively or additionally, the number of dials placed per second can be limited to a known value that has been established empirically, and/or this value can be configured through a server parameter provided as part of statistical information input 414. In still other forms, the controller can track the number of calls placed system-wide and determine call placement based on system-wide loading before dialing. If the load is too high, the contact is queued for later processing.

In yet a further example, Special Information Tone (SIT) results are used as part of the input to prediction logic 410 for use in the decision to place another call. The SIT returns indicate that a given telephone number is not active or is presently unavailable, which can be summarized into the following categories: No Circuit, Intercept, Vacant Code, Recorder, and Ineffective Other.

In still a further example, for an arrangement that includes one outbound workgroup and many inbound workgroups for a workflow, statistical information input 414 could include a max and min value that can pause contact placement prediction. Also, this approach can allow for definition of a total max/min value that would control the prediction and generation of calls for a workflow. Further statistics that could be included in input 414 are described in connection with Tables I-IV and FIGS. 15-20 hereinafter.

Aggressiveness information input 416 provides a parameter to adjust the overall pace of outbound contact placement relative to all other parameters, statistics, stages, and factors influencing the placement prediction. As such, it can be adjusted by operator input through a GUI button, slider, or the like. Alternatively, input 416 can be included within another input or may be absent.

Configuration logic 420 defines properties and characteristics of a workflow, campaign, and/or individual contact within a campaign to which prediction logic 410 and ultimately predictive outbound contact logic 400 is responsive. Referring additionally to FIG. 7, selected aspects of configuration logic 420 are specifically designated by reference numerals for ease of further description that follows. Configuration logic 420 defines properties at the workflow level 430 and at the associated campaign level 440. Contact level 450 is representative of attempted contacts associated with a given campaign. The nested levels 430, 440, and 450 are represented by rectangular boxes in FIG. 7.

At workflow level 430, scheduling configuration information 432 is defined that indicates when a given workflow is on or off, as well as other timing information. For a workflow involving contacts in different time zones, time zone adjustments and/or limitations may be included in scheduling configuration information 432. In other embodiments, scheduling configuration information may be absent.

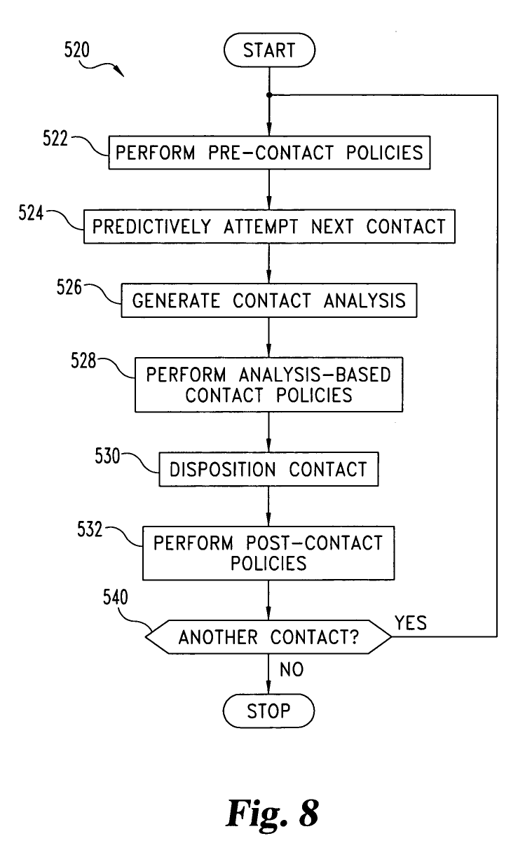

At campaign level 440, contact list information 442 is provided, which is typically in the form of a database with multiple fields/entries defined for each potential contact in a corresponding database record or table. This list can include attributes utilized in making various processing decisions during performance of a campaign as will be more fully explained in connection with FIG. 8 hereinafter.

Staging definitions 444 are also provided at the campaign level 440. As previously described in connection with FIGS. 1-4, staging corresponds to discrete phases of a contact communication. For a predictive dialing campaign that connects agents (via ACD or otherwise) to calls that are answered by a person, each stage can be a different task that an agent performs or completes during the telephone conversation, or as otherwise previously described in connection with FIGS. 1-4.

By way of nonlimiting example, different stages can be triggered by a greeting, pitch, objection, order entry, sale, closing, or the like during the conversation as signified by a keyboard/mouse or other input device signal initiated by an agent on the call or detected from the progression of a script or other indicator corresponding to the defined stages. In a blended environment where both inbound and predictively initiated outbound contacts are made, stages of inbound communications between an agent and another can be defined and used to predict availability for outbound contact placement. Alternatively, staging can be used only with conversations resulting from predictively placed outbound contacts in either a blended inbound/outbound environment or exclusive outbound environment. As previously noted, staging may be absent in other embodiments.

At the contact level 450, once an individual is engaged in conversation with an agent, one or more scripts 452 may be utilized. Alternatively or additionally, scripting for any IVR interface with the contacted person can be included in scripts 452. In still other embodiments, there may be no scripts.

Operatively connected to both workflow level 430 and campaign level 440 are workflow level rules and/or campaign level rules 460. Such a rule is conditional, being responsive to one or more conditions of the corresponding workflow or campaign to select between two or more behaviors (actions) and to execute the selected behavior (action). The one or more conditions can include a statistic, event, time, or the like. Possible behaviors or actions that could be selected based on a condition include, but are not limited to, sending an email, running a handler/macro, logging a value, changing campaigns, passing control to a different set of rules, and the like. Correspondingly a given rule is associated with either a workflow or campaign. Multiple rules can be provided that are executed in order with the optional ability to bypass one or more rules as a behavior.

In one embodiment, a dialer of the present invention facilitates the definition of rules and actions that operate on statistics gathered at various operating intervals. The rules allow the performance of certain actions when events occur or when a selected statistic reaches a defined level. These actions can operate globally on the workflow (or campaign) and may not affect the individual contacts that constituted the actual work being performed.

Configuration logic 420 also includes contact level policies 470. Policies 470 are similar to rules 460, but operate for each contact rather than for a workflow or campaign. A policy is a conditional rule that is responsive to one or more conditions relating to the corresponding contact to select between two or more behaviors (actions) and execute the selected behavior (action). As used herein, in one nonlimiting example, the two or more behaviors (or actions) can be comprised of a first behavior of performing an operation and a second behavior of not performing such operation (typically, in effect, the second behavior bypasses such operation). In another nonlimiting example, the two or more behaviors (or actions) can be comprised of a first behavior of performing a first operation and a second behavior of performing a second operation, where the first and second operations differ in such a manner that one is not merely refraining from performance of or bypassing the other.

Contact level policies 470 are user-defined rules that operate on a contact-by-contact basis, permitting more granular actions to be performed on the contact. By way of nonlimiting example, a policy set of one or more policies can be associated with a campaign. The policy set is a top level object composed of one or more policy objects. The policy objects in a policy set are evaluated in order. The interface will allow specification of the order of the lists. Policy objects can have a termination type which states whether evaluation should continue on subsequent policy objects in the list. A policy might be used as a reward notification mechanism. For instance, after a contact completes, the revenue attribute could be compared for high sales calls. If this condition was met, the behavior could be to send an email, send a page, write a message to an event log, or to trigger a handler procedure. This notification would allow the call center manager to appropriately reward the agent. Another policy might override some or all of a campaign's automatically scheduled settings for the particular contact. For instance, the condition might check that this contact has been attempted several times and choose to schedule a callback for the afternoon or evening instead. A customer convenience policy might check for a condition on a custom attribute to determine that this customer would prefer to be called on their work phone before their cell phone and to never call their home phone (e.g. they are purchasing an anniversary gift). The behavior would be to set a different contact order than is executed by default for the campaign.

Referring to FIG. 8, procedure 520 is depicted in flowchart form that includes three different contact level policy types. Procedure 520 begins with operation 522 in which any designated pre-contact policy types are executed. A pre-contact policy of operation 522 is executed before placement of the next contact; however information for that contact can be utilized by such policy as a condition. For example, an attribute from a database record for the next contact can indicate that a different script is to be used for the particular contact and/or that a special agent skill is required. In another example, a pre-contact policy is established to adhere to a mandated requirement that a telephone call contact cannot be abandoned more than once by a call center after an automatically dialed call is answered. In this example, the number of abandonments serves as the one or more conditions for the policy, and the behavior could be any of: skipping the call, marking the call so that it is never called again, scheduling the call for a callback that cannot be abandoned, or precisely dialing the contact which ensures an agent is available before the call is physically placed. In still another example, a database record for the next contact includes different telephone numbers such as a cellular phone number, work phone number, and home phone number; and the campaign specifies a default contact order; however, a database attribute (a type of policy condition) is evaluated to determine if the order should be changed (a policy behavior) for the particular contact. In yet another pre-contact policy example, an attribute indicating the prospective contact's preference to be contacted by facsimile or email instead of by telephone can be evaluated as a policy condition to select from among corresponding policy behaviors of generating a facsimile or an email, respectively (if the evaluation of the condition indicates the preference) and placing a telephone call (if the evaluation does not indicate the preference).

Procedure 520 proceeds from operation 522 to operation 524. In operation 524, the next contact is predictively attempted in accordance with logic 400, including any contact-specific adjustments made as a result of one or more pre-contact policies executed in operation 522. Based on operation 524, an analysis of the contact attempt is performed in operation 526. This analysis provides data regarding if and how the contact is answered. Accordingly, the analysis results for a telephone call type of contact can indicate any of the following: (1) call answered by a person (a successful contact), (2) call answered by a voice recording machine (such as an answering machine or voice mail), (3) call answered by a facsimile machine, (4) called number busy, (5) no answer after a designated time period, and (6) call otherwise not completed as might be further explained by detecting Special Information Tones (SITs), just to name a few possibilities.

Following operation 526, one or more contact analysis policies are executed in operation 528. This policy type is executed after analysis results are available, but before the contact is completed. One example of a contact analysis policy includes sending an email to the prospective contact (a first conditional policy behavior) if the analysis results indicates that the call was not successfully answered by a person (policy condition(s)), and to otherwise connect the called party (customer) to an agent or IVR (a second conditional policy behavior). In another example, a fax is sent (a first conditional policy behavior) only if evaluation of the analysis results (policy condition(s)) indicate answering by a facsimile machine, and otherwise to refrain from faxing (a second conditional policy behavior).

From operation 528, procedure 520 continues with operation 530. In operation 530, the contact is completed. For a successfully answered telephone call type of contact, operation 530 may include the execution of one or more scripts 452, operation of an IVR, assignment and connection to an agent by ACD, and/or staging associated with different states of a conversation between a contact and agent, to name only a few possible events. After operation 530, any post-contact policies are executed in operation 532. In one example of a post-contact policy, the condition evaluated is whether a certain level of sales has been completed by an agent and the behavior selected when the evaluation is affirmative includes sending a congratulatory email to such agent, otherwise the behavior or action is to refrain from sending such an email. A further example of a post-contact policy includes evaluating an agent entry into a database record for the contact (a policy condition) to determine whether or not to schedule a follow-up contact (the possible policy behaviors).

Procedure 520 continues with decision operator 540, which tests whether there is another potential contact to be attempted. If the test of operator 540 is affirmative (true), procedure 520 returns to operation 522 to process the next contact, repeating operations 522-532, before testing again for another contact with operator 540. If the test of operator 540 is negative (false), then procedure 520 terminates, until called again. It should be understood, that in other embodiments not all three types of contact level policies are used and/or available. Alternatively or additionally, different policy types may be used. In still other embodiments of the present invention, contact level policies are absent.

Referring to the contact level policies in general, the one or more conditions for each operator can be evaluated with Boolean operators (i.e. and, nand, or, nor, exclusive or, not operators); by arithmetic comparison (such as, less than (<), less than or equal to (≦), greater than (>), greater than or equal to (≧), equal (=), and not equal (<>) operators), optionally including mathematical calculations on one or both sides of the comparison operator; time evaluation operators; date evaluation operators; and/or by character string operators, to mention some representative examples. It should further be appreciated that some conditions would not be available for certain types of policies. For instance, generally a condition from contact analysis would not be applicable to a pre-contact policy.

As a supplement to previous policy examples, further description of various condition types is provided, with certain limitations as to the policy types described. For example, attributes (data associated with the contact being placed), call category (normal, scheduled callback, etc . . . ), statistic(s) (system statistic(s) such as abandonment rate), and/or time (time of day, range), can be used by any of the three policy types of procedure 520. For instance, given an attribute that indicates when a contact payment is due, selection among different behaviors can be made depending on whether payment is past due by a certain amount of time. For a time of day condition, selection among different behaviors can result depending on whether the contact is placed during typical work hours.

A few conditions that are not applicable to all of the three contact level policies include call analysis results, which are not available for a pre-contact policy type. Likewise, a contact duration condition would be inapplicable to a pre-contact policy type because the contact has not yet started (always a “zero” duration). Another limitation arises in connection with disposition codes that are entered only after a contact is completed. As a policy condition, such codes would only be applicable to the post-contact type of policy.

As in the case of policy conditions, policy behaviors can also be limited to only certain of the policy types described in connection with procedure 520. For instance, it does not make sense to have a “calling party” behavior evaluated after the call has already been initiated, so this behavior type is only applicable to pre-contact policies. Various behavior types include setting one or more data attributes for the contact that, optionally, could be displayed on an agent's workstation, scheduling a callback, sending an email or page, routing to an automated attendant profile implemented with an IVR, and/or moving the contact to another campaign by adding the contact data to the contact list for a different campaign. In one implementation of this last instance, when a contact purchases a product as a result of a marketing campaign, the contact is moved to a customer campaign from the marketing campaign.

Behaviors that would typically only be applicable to the pre-contact type of policy include changing the default dialing order of multiple telephone numbers or other contact types in the manner previously described in connection with operation 522. Another pre-contact specific behavior involves script selection based on a given attribute and/or some other applicable condition. Also, pre-contact specific is setting a calling party name/number, (i.e. Automatic Number Identification (ANI)), when there is an attribute that specifies to use different “calling party” information for the specific contact. A behavior to specify how the call should be routed is applicable to the pre-contact type of policy. This behavior could be combined with one or more notifications to specify what to do with the contact. Alternatively or additionally, this behavior type allows for the specification of any ACD skills to assign to the contact, such as an alternate language agent, which could be determined based upon an attribute for the contact. Different call routing type can include: “route normally” that routes the contact in the standard way, (which could be implied if no other route-type behaviors are specified); “route precisely” that waits until an agent is available, and can be implemented further by pulling an agent out of the workflow, placing the contact, waiting for contact completion, then returning the agent to the workflow; “do-not-dial” that refrains from dialing a telephone number-based contact; and/or “preview” that presents certain contact information to an agent before initiating contact, which may perhaps be desired for contacts with a special history. Still another pre-contact specific type of behavior is one that specifies the type of contact analysis to be performed in operation 526 and/or enables/disables contact analysis.

Behaviors applicable to contact analysis and/or post-contact policy types include Specifying one or more codes regarding the disposition of a contact and performance of “agentless” activities, such as sending a fax, email, or voice recording; or utilizing an IVR-based automated attendant profile in lieu of agent.

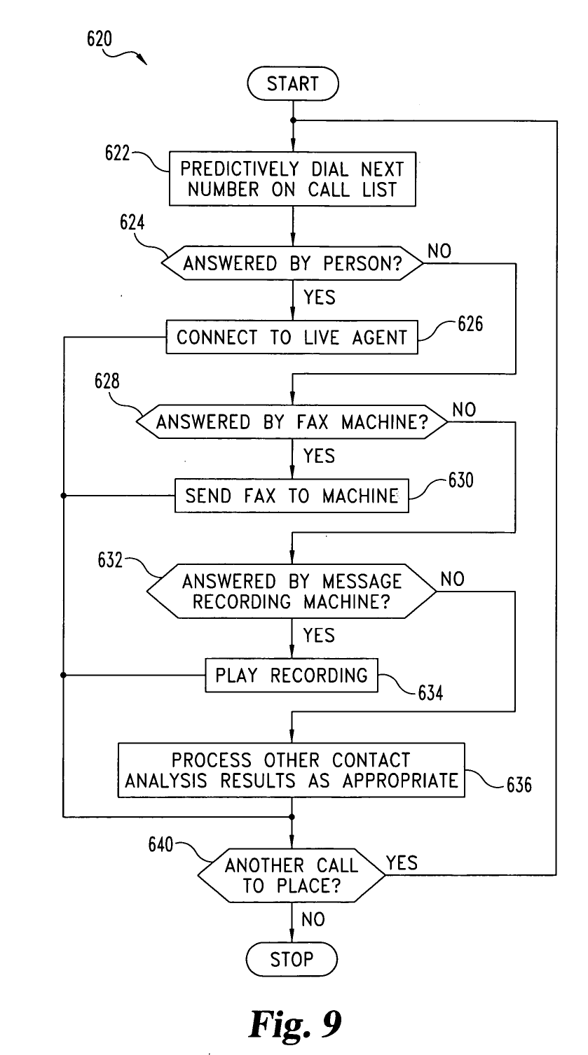

FIG. 9 illustrates another embodiment of the present in flowchart form as multimedia contact procedure 620 executed by a contact center. Procedure 620 can be implemented in the operating logic of system 20 and/or system 320—either as part of logic 400, separate from logic 400, or without logic 400. Procedure 620 starts with operation 622 in which a telephone number from a call list is dialed with predictive dialer 71 from a contact center (see FIG. 2). Procedure 620 performs a call analysis as part of operation 622, which returns corresponding analysis results. Operation 622 may be performed as part of a campaign/workflow.

The analysis results from operation 622 are utilized by decision operator 624 to test if the predictively dialed call was answered by a person (success). If the test of operator 624 is affirmative (true), then procedure 620 continues with operation 626. In operation 626 the called person is connected to an agent. Operation 626 can connect the called person to an IVR-based automated attendant before connection to the agent and/or after connection to the agent; or in lieu of connection to the agent altogether (an “agentless” call contact). Connection to an agent in operation 626 can optionally be performed with an ACD utilizing agent skill criteria and/or various statistics in a standard manner. If the test of operator 624 is negative (false), then procedure 620 continues with decision operator 628.

Decision operator 628 tests if the call was answered by a facsimile machine. If the test of operator 628 is affirmative (true), then a fax is sent to the facsimile machine from the contact center in operation 630. Referring also to FIG. 5, external facsimile (fax) machines 24a of potential contacts are illustrated in system 320. Machines 24a are coupled to PSTN 22 in a standard manner. Likewise, one or more of machines 24a could be coupled to PSTN 22 of system 20, but are not shown to preserve clarity. Operation 630 can be performed in addition to rescheduling the contact to later retry reaching the person for connection to an agent or in lieu of rescheduling the agent contact. If the test of operator 628 is negative (false), then procedure 620 continues with decision operator 632.

Decision operator 632 tests if the call was answered by a voice recording machine, which could be an answering machine or voicemail, to name a couple of examples. If the test of operator 632 is affirmative (true), then a recorded voice message and/or other sound recording is sent to the voice recording machine from the contact center in operation 634. Referring also to FIG. 5, voice recording machines 24b of potential contacts are illustrated in system 320. Machines 24b are coupled to PSTN 22 in a standard manner, and can each be in the form of an answering machine and/or voice mail device either locally or remotely located relative to the corresponding contact. In one form, voice mail service is provided by a local phone company with the corresponding device being located on telephone company premises. Likewise, one or more of machines 24b could be coupled to PSTN 22 of system 20, but are not shown to preserve clarity.

Operation 634 can be performed in addition to rescheduling the contact to later retry reaching the person for connection to an agent or in lieu of rescheduling the agent contact. In one form, the recording sent to the voice recording machine in operation 634 is generated from a digitized WAV file stored in memory associated with server 40 (see FIG. 1). Alternatively, other forms of sound recording and sound storage could be utilized. If the test of operator 632 is negative (false), then procedure 620 continues with operation 636.

Operation 636 processes the call as desired if answered differently than indicated in operators 624, 628, and 632; or if not answered or busy. In one form, operation 636 includes sending an email to the potential contact if an email address is available. Referring also to FIG. 5, external contact computers 360 of potential contacts are illustrated in system 320. Computers 360 are coupled to WAN 352 in a standard manner, and are arranged to receive email from any of servers 40 or 330. Alternatively or additionally, computers 360 could be coupled to network 52 of any of contact centers 322, 324, or 326 or of system 20, which is not shown to preserve clarity.

Optionally, a follow-up telephone call can be scheduled for a later time in operation 636. After operation 636, decision operator 640 is encountered. Procedure 620 also reaches operator 640 after executing any of operations 626, 630, and 634. Operator 640 tests if there is another call to be placed. If the test of operator 640 is affirmative (true), procedure 620 continues by returning to operation 622. If the test of operator 640 is negative (false), then procedure 620 terminates until called again. It should be appreciated that procedure 620 could be partly or completely implemented in the properties of a campaign, through contact level policies, or in other operating logic independent of these entities.

In an effort to ease the administrative burden and simplify the workflow/campaign creation process, wizards can be included in further embodiments of a predictive dialer that can walk the user through the various steps required to enable a running workflow. Additionally, the campaign server can be extended to include the capability to create all applicable workflow and campaign tables and indexes.

Based upon entry point, a subset of several unique system setup wizard pages is provided. For instance, from a campaign utility tab, a “create tables” button can be provided that would run the Table creation wizard steps against that single campaign. Those same steps would be shown when configuring a full campaign, which in turn would be shown when configuring a full workflow. One aspect of this embodiment is to allow wizards in various places that setup narrowed tasks according to the context while being consistent in what pages are presented for a given task, regardless of what level of wizard is used.

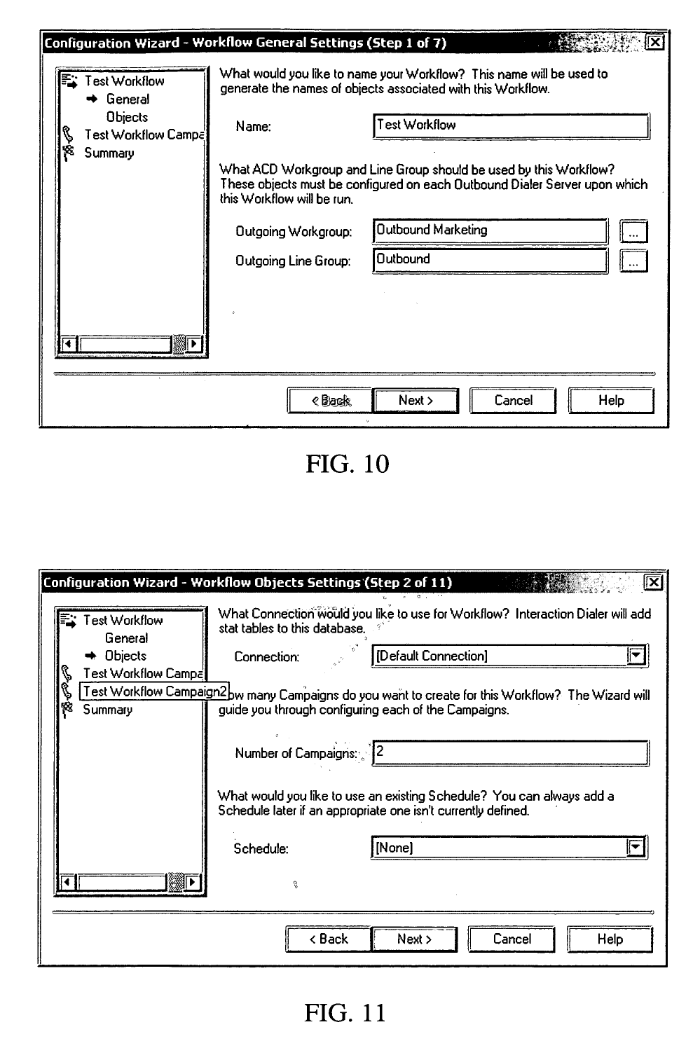

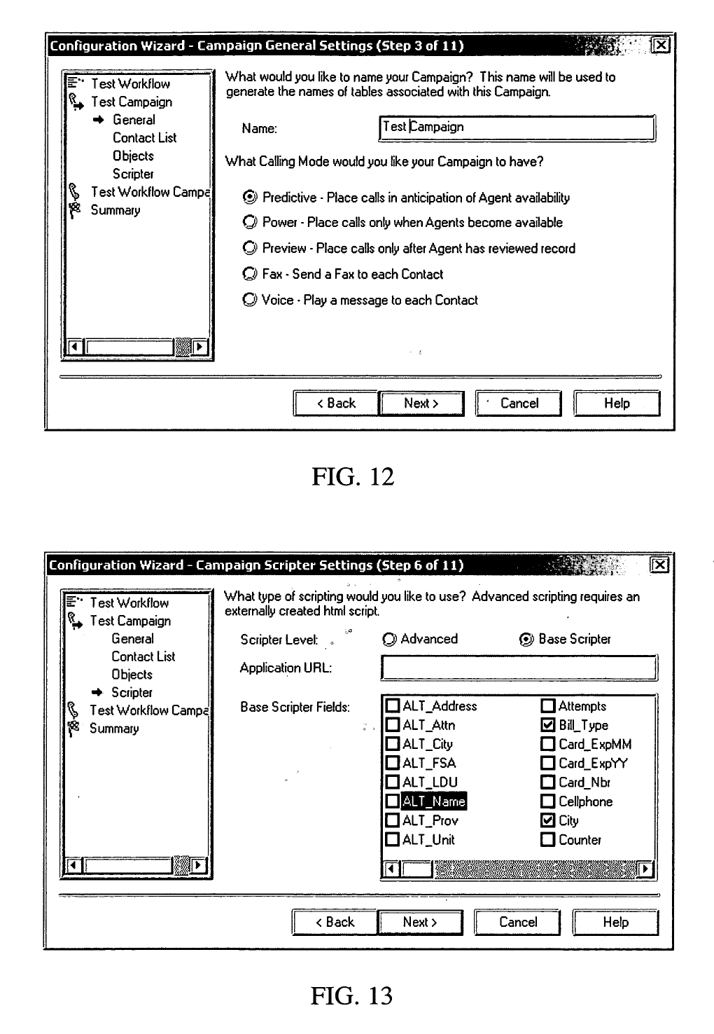

FIGS. 10-14 depict exemplary GUI wizard pages to establish various aspects of predictive dialing in one embodiment of the present invention. As specifically depicted in FIG. 10, a workflow wizard page allows an operator (typically a supervisor) to name the workflow and create an association with the appropriate workgroup and linegroup for such an embodiment. As depicted in FIG. 11, an objects settings page allows the user to define how many campaigns are to be part of the workflow as well as what connection and schedule to use for the workflow. The number of campaigns entered can directly change the number of stages that the wizard presents before proper completion. A campaign wizard page is depicted in FIG. 12 that allows the user (typically a supervisor) to name the campaign and declare the calling mode desired. A dialer form setup page of the wizard is depicted in FIG. 13, with which the user can define what fields (directly from the Call List) are to be shown on the dialer page. In FIG. 14, a summary page is depicted that shows what will be presented according to the user's input on the detail pages. Once finish is selected, all of the appropriate tables and indexes are created based on the name of the campaign with which they are associated.

Call center supervisors sometimes desire a way to view real-time outbound contact and/or dialer statistics for monitoring the status of workflows. In another embodiment of the present invention, a dialer supervisor plug-in is provided that includes a set of custom supervisor view objects that are hosted by a Contact Supervisor (CS) logic module. These view objects allow viewing of real-time dialer statistics and status monitoring. For each view object type the dialer supervisor plug-in contains, it provides an interface to access the menu, toolbar, doc, view, help, and other information needed by CS to host the plug-in. In this embodiment, it can be desirable for the user to be able to display all the various dialer pieces on the screen at the same time and/or to mix-and-match dialer statistic controls showing statistics for different workflows. In one form, the user can create two instances of the same statistical display, but for different workflows and/or the user can create two different statistical displays for the same workflow so that they can simultaneously see multiple statistics for that workflow.

Various workflow level statistics that could be utilized with this embodiment are provided by way of nonlimiting example in Table I that follows:

TABLE I

| Statistic | Description |
|---|---|
| Pace | This value reports the current pace of a workflow. |
| Agents Logged In | The number of agents who are currently logged in to the campaign. |
| Active Agents | The total number of outbound active calls, including calls |
| | that are connected and calls that are disconnected but are |
| | awaiting completion information to be sent by agents who are |
| | currently in a follow-up state. |
| Active Calls | The total number of outbound active calls, including calls |
| | that are connected and calls that are disconnected but are |
| | awaiting completion information to be sent by agents who are |
| | currently in a follow-up state. |
| Filter | This field displays Filter Criteria used by the campaign. |
| Order By | This field contains comma-separated values that indicate the |
| | current sort order of the Contact List. |
| Recycle Size | This value indicates the number of records in the Contact |
| | List that must be processed before the list is recycled. |
| Remaining Recycles | Number of recycles left in the current campaign |
| Est. Completion | This is the estimated number of days, hours, minutes, and |
| | seconds that it will take to finish processing the Contact List, |
| | based upon the current rate of call processing. Note: Only |
| | for the current Recycle |
| Calls Per Hour | This is the average number of outbound calls placed per hour |
| | during the campaign. |
| Non-Campaign Calls | This value indicates the current number of active non- |
| | campaign calls. |
| Calls Per Request | This is the number of calls that the Outbound Dialer server |
| | estimates that it must place in order to connect with a live person. |
| Adj. Calls Per Request | This statistic is similar to Calls Per Request, except that the |
| | pace of the campaign is also factored in. |
| Active Servers | The number of active ODS servers participating in the |
| | workflow. |
| Last Error | The last error that occurred on this workflow. |
| Last Warning | The last warning that occurred on this workflow. |

Further nonlimiting examples of statistics for this embodiment are shown in Table II below. These statistics are agent-oriented and are directed to period, shift, recycle, campaign, and/or workflow aspects of outbound dialer activity relative to a selected workflow. In one form, the statistics of Table II are selectively presented per-agent or for all agents of the selected workflow, as desired by the supervisor:

TABLE II

| Statistic | Description |
|---|---|
| Contacts | The number of live parties that the agent has spoken to. |
| Contact Rate | The ratio of Contacts to Calls Placed, expressed as a |
| | percentage. |
| Successes | The total number of calls that ended with a successful Finish |
| | Code. |
| Success Rate | This is the ratio of successes to contacts, expressed as a |
| | percentage. |
| Calls Placed | The total number of calls placed for the period, shift, recycle, |
| | campaign, or workflow. This stat is for [All Agents] and will |
| | be N/A for a single agent. |
| Calls Abandoned | The total number of abandoned calls during the period, shift, |
| | recycle, campaign, or workflow. |
| Dialer Calls | The total number of Dialer calls that the agent has participated |
| | in during the reporting period. |
| Total Dialer Talk Time | Total amount of time this agent was on Dialer calls. |
| Avg. Dialer Talk Time | Average amount of time, per call, this agent was on Dialer |
| | calls. Expressed in MM:SS. |
| Percent Dialer Time | Percent of time agent spent on Dialer calls. |
| Non-Dialer Calls | The total number of non-Dialer calls, including inbound and |
| | personal calls received by the agent. |
| Total Non-Dialer Talk | Total amount of time this agent was on non-Dialer calls. |
| Time | |
| Avg. Non-Dialer Talk | Average amount of time, per call, this agent was on non-Dialer |
| Time | calls. Expressed in MM:SS. |
| Percent Non-Dialer | Percent of time agent spent on non-Dialer calls. |
| Time | |
| Total Talk Time | Total amount of time this agent was on a call. Expressed in |
| | minutes per hour. |
| Average Talk Time | The average amount of time, per call, that the agent spends on |
| | a call. |
| Total Idle Time | Total number of seconds this agent was not on a call. |
| Average Idle Time | Average number of seconds, per idle, until this agent received |
| | a call. |
| Percent Idle Time | Percent of time agent spent idle. |
| Total DND Time | Total number of seconds this agent was in Do Not Disturb |
| | DND). |
| Average DND Time | Average number of seconds, per DND, that the agent spent on |
| | break. |
| Percent DND Time | Percent of time agent spent in DND. |
| Stage | This field displays the name of the stage that the call is |
| | currently in. |
| Time in Stage | This is the amount of time that the agent has remained in the |
| | current stage, during the agent's current call. |

Another nonlimiting set of statistics that can be used in this embodiment are directed to contact completion or “finish” codes as shown in Table III. These statistics are relative to a specific workflow and can also be selectively displayed per-agent or for all agents, as desired by a supervisor.

TABLE III

| Statistic | Description |
|---|---|
| Total Calls | The number of calls that were assigned this finish code by agents. |
| % of Calls | The percentage of all calls that were assigned this finish code. |
| Total Time | The total time that agent(s) spent on calls that resulted in this finish code. |
| % of Time | The ratio of time consumed by calls in this finish code, relative to the time |
| | required to process all calls in the campaign. |
| Average | The average time that agent(s) spent on calls that resulted in this finish code. |
| Time | |

Still another nonlimiting category of statistics for this embodiment directed to staging is shown in Table IV. These statistics are relative to a specific workflow and can be selectively viewed on a per-agent or all agent basis for the selected workflow, as desired by a supervisor.

TABLE IV

| Statistic | Description |
|---|---|
| Entered | The number of calls that entered this call stage. |
| Completed | The number of calls that finished in this call stage. |
| % Completed | The percentage of total calls that finished in this call |
| | stage. |
| Total Time | The total amount of time spent in this call stage. |
| Average Time | The average amount of time spent in this call stage. |

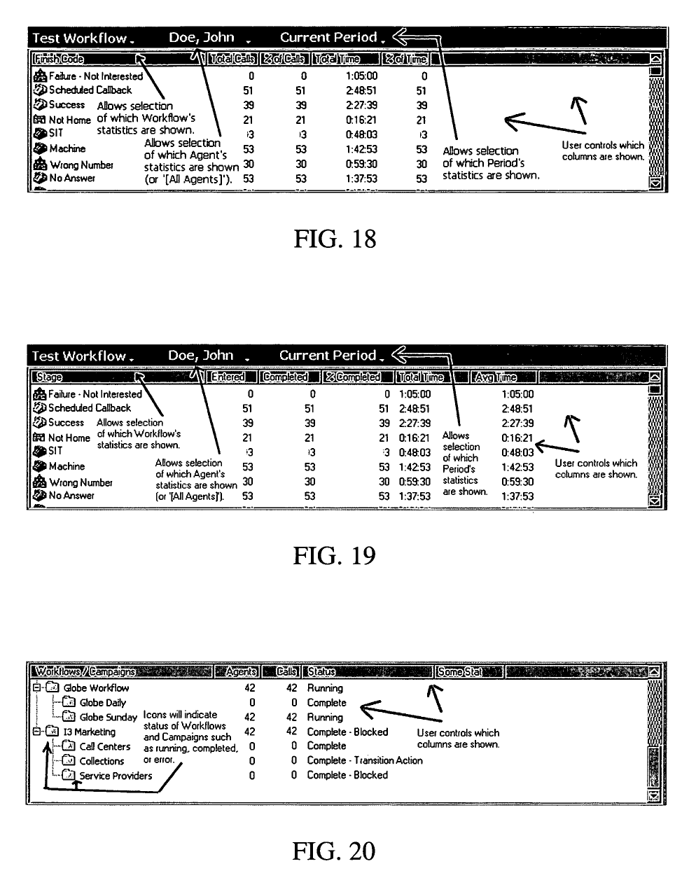

FIGS. 15-20 illustrate sample GUI statistical presentation screens that could be utilized in connection with this embodiment. FIG. 15 provides a nonlimiting example of how workflow statistics corresponding to Table I might be summarized. FIG. 16 provides a nonlimiting example of how detailed agent statistics corresponding to Table II might be presented. FIG. 17 provides a nonlimiting example of a detailed workflow statistical presentation that is specific to a given agent. FIGS. 18 and 19 provide nonlimiting examples of various statistics for contacts of a given workflow and agent in terms of contact finish codes and call stages, generally corresponding to Tables III and IV, respectively. FIG. 20 provides a nonlimiting example of overview statistics relative multiple workflows and/or multiple campaigns for this embodiment. This workflow overview of FIG. 20 displays information about all running workflows at the same time, and includes workflow status, such as whether the workflow has completed and what caused it to complete.

Another embodiment of the present invention is a unique system for attempting to establish new communication links with customers or prospective customers based on the substantive progress of communications with individuals currently connected to the system.

In still another embodiment, a predictive dialer bases outbound dialing decisions at least in part on current or recent information concerning the substantive stage of calls then in progress (such as an offer phase, acceptance phase, question-and-answer phase, and closing phase). In some such forms, the agent is presented with a telemarketing script in a video display to guide his or her information presentation and collection. The substantive stage of a call in some such systems is inferred from the navigational commands and data input made by the agent via the scripting system. In other systems, the agent explicitly generates signals to the system to notify the system of the substantive status of the agent's current phone call.

In a further embodiment, unique contact procedures/policies are provided in an automatic outbound dialing technique. In one form, these contact policies include a triggering condition and one or more behaviors in the form of contact rules for pre-call analysis, post-call analysis, and/or post-call disposition.

In yet a further embodiment, workflow monitoring across multiple automatic dialer servers is provided. In one form, this technique provides centralized monitoring via a statistics collection process provided for a supervisor of the multiple dialer servers.

Still a further embodiment includes unique campaign techniques that are partially or totally agentless. Among the forms of this embodiment are using call analysis and campaign contact list management to execute an automatic interactive voice response (IVR) procedure that is agentless or has only limited agent involvement, to automatically provide a voice message, fax, email message, page and/or SMS message automatically with the optional ability to use contact policies if desired.

A further embodiment includes: one or more devices encoded with logic to configure a predictive outbound contact campaign when executed with one or more servers. The predictive outbound contact campaign is associated with a list of prospective contacts. The logic is effective to selectively include: a pre-contact policy that is evaluated before each of the prospective contacts from the list is initiated, and which is responsive to one or more pre-contact conditions to select between at least two pre-contact behaviors; a contact analysis policy that is evaluated after each of the prospective contacts is initiated, and which is responsive to one or more characteristics of one of the prospective contacts before it is completed to select between at least two processing behaviors; and a post-contact policy that is executed after each of the prospective contacts is completed, and which is responsive to at least one contact condition to select between at least two post-contact behaviors. In one form of this embodiment the conditions or behaviors are selected from among those previously described in connection with procedure 520.

Another embodiment includes: performing a predictive dialing campaign that is associated with a list of prospective contacts; processing each of the prospective contacts in a desired sequence during campaign performance; evaluating a contact policy for each one of the prospective contacts as the one of the prospective contacts is being processed—where such contact policy is responsive to one or more conditions corresponding to the one of the prospective contacts to select between at least two different processing behaviors; determining one or more campaign characteristics as a function of processing several of the prospective contacts; and executing a campaign rule to adjust campaign performance—where such campaign rule is responsive to at least one of the campaign characteristics to select between at least two different actions. In one form of this embodiment the conditions or behaviors are selected from among those previously described in connection with procedure 520.

In still another embodiment, a system comprises one or more servers operable to perform a predictive contact campaign; where the one or more servers each include means for processing each of a number of prospective contacts in a sequence. This processing means includes: means for evaluating a contact policy for each one of the prospective contacts being processed—where such contact policy is responsive to one or more conditions corresponding to the one of the prospective contacts to select between at least two different processing behaviors; means for determining one or more campaign characteristics as a function of processing several of the prospective contacts; and means for executing a campaign rule to adjust performance of the predictive contact campaign that is responsive to at least one of the campaign characteristics to select between at least two different actions. In one form the contact policy is one of the types described in connection with procedure 520.

A further embodiment includes: operating a multisite server arrangement including a coordinating server coupled to one or more other servers by a wide area computer network, in which the coordinating server and two or more other servers each are associated with one of at least two contact centers remotely located relative to one another; performing at least two contact campaigns of a workflow with the multisite server arrangement, which includes each of the two or more other servers automatically placing calls with a predictive dialer; controlling the workflow with the coordinating server, which includes directing collection of performance statistics; and reviewing the performance statistics of one of the two or more servers from another of the two or more servers. In one form, at least a portion of performance statistics are selected from among those types listed in Tables I-IV and/or the types shown in FIGS. 15-20.

Yet a further embodiment includes a multisite server arrangement that has: a coordinating server coupled to one or more other servers by a wide area computer network, means for performing multiple campaigns with each of the two or more other servers automatically placing calls with a corresponding predictive dialer, means for controlling the workflow with the coordinating server including means for collecting performance statistics; and means for reviewing the performance statistics of one of the two or more servers from another of the two or more servers. In one form, at least a portion of performance statistics are selected from among those types listed in Tables I-IV and/or the types shown in FIGS. 15-20.

Still a further embodiment of the present invention includes: automatically dialing a telephone number with a predictive dialer to place a call from a contact center; if the call is answered by a person, connecting the call to an agent at the contact center; if the call is answered by a facsimile machine, sending a facsimile to the facsimile machine from the contact center; and if the call is answered by a voice recording machine, transmitting a recorded message to the voice recording machine from the contact center. Optionally, this embodiment may also include: directing the call to an IVR before connecting the call to the agent if the call is answered by the person, distributing the call to the agent with an ACD, predictively dialing another telephone number with the predictive dialer as a function of a number of different stages of a conversation between an agent and a person during the call, and/or sending an email to the person if the call is not answered.

Another embodiment includes one or more wizards that are composed of narrowed tasks that are displayed according to the context while being consistent with what pages are presented for a given task, regardless of what level of wizard is used to simplify administration.

A further embodiment includes a predictive outbound dialing technique to contact each of a number of the contacts from a contact center that includes a plurality of agents. The embodiment including dialing each one of several of the contacts before designating one of the agents to handle a call if the one of several of the contact answers and selecting at least one other of the contacts for a different process, the different process including designating one of the agents to handle a call placed to the one other of the contacts before dialing this call. The process may further include removing the one of the agents from ACD, workflow, or other duties for the different process until after such agent has handled the call to the one other of the contacts.

Any theory, mechanism of operation, proof, or finding stated herein is meant to further enhance understanding of the present invention and is not intended to make the present invention in any way dependent upon such theory, mechanism of operation, proof, or finding. Any publications, U.S. patent applications, or U.S. patents cited herein are each hereby incorporated by reference herein in its entirety, including, but not limited to: U.S. patent application Ser. No. 09/616,083 filed 13 Jul. 2000; U.S. Provisional Patent Application No. 60/467,543 filed on 2 May 2003; U.S. Provisional Patent Application No. 60/186,487 filed on 2 Mar. 2000; and U.S. Provisional Patent Application No. 60/143,460 filed on 13 July 1999. While the invention has been illustrated and described in detail in the figures and foregoing description, the same is to be considered as illustrative and not restrictive in character, it being understood that only selected embodiments have been shown and described and that all changes, modifications and equivalents that come within the spirit of the invention as defined herein or in any of the claims that follow are desired to be protected.

1. An apparatus, comprising: one or more devices encoded with logic to configure a predictive outbound contact campaign when executed with one or more servers, the predictive outbound contact campaign being associated with a list of prospective contacts, the logic being effective to selectively include:
a pre-contact policy that is evaluated before each of the prospective contacts from the list is initiated, the pre-contact policy being responsive to one or more pre-contact conditions to select between at least two pre-contact behaviors;
a contact analysis policy that is evaluated after each of the prospective contacts is initiated, the contact analysis policy being responsive to one or more characteristics of one of the prospective contacts before it is completed to select between at least two processing behaviors; and
a post-contact policy that is executed after each of the prospective contacts is completed, the post-contact policy being responsive to at least one contact condition to select between at least two post-contact behaviors.

2. The apparatus of claim 1, wherein the one or more devices include at least one memory device and at least a portion of the logic is in the form of programming instructions.

3. The apparatus of claim 1, wherein the logic is further effective to selectively define a workflow and a plurality of campaigns for the workflow, the predictive outbound contact campaign belonging to the plurality of campaigns.

4. The apparatus of claim 3, wherein the logic is further effective to selectively include one or more workflow or campaign level rules, the one or more rules being responsive to one or more workflow or campaign conditions to select between at least two behaviors.

5. The apparatus of claim 1, further comprising a server and a plurality of agent workstations coupled to the server, the server including a predictive dialer to perform the predictive outbound contact campaign, the list corresponding to a plurality of contact telephone numbers, the workstations each including one of a plurality of agent telephones.

6. The apparatus of claim 5, wherein the logic is further effective to define an automated contact distributor to selectively connect a plurality of telephone calls each established with the predictive dialer to one of a corresponding number of agents.

7. The apparatus of claim 1, further comprising a multisite server arrangement including a plurality of servers, at least two of the servers being at different contact centers remotely located relative to one another, the logic being operable to distribute performance of the predictive outbound contact campaign across the plurality of servers, one of the servers being a coordinating type operable to coordinate the performance of the predictive outbound contact campaign by other of the servers.

8. The apparatus of claim 1, wherein the logic defines means for reviewing campaign performance information of one of the servers from another of the servers.

9. The apparatus of claim 1, wherein the logic defines a procedure to: automatically dial a telephone number with a predictive dialer to place a call from a contact center, connect the call to an agent of the contact center if the call is answered by a person, send a facsimile to a facsimile machine from the contact center if the call is answered by the facsimile machine, and transmit a recorded message to a voice recording machine from the contact center if the call is answered by the voice recording machine.

10. The apparatus of claim 1, wherein:
the one or more pre-contact conditions include a contact attribute and the pre-contact behaviors include changing routing of the contact based on the contact attribute;
the one or more characteristics include one of a plurality of answer types, and the processing behaviors include at least one of automatic contact distribution to an agent, sending a fax to a facsimile machine, and sending a recording to a voice recording machine; and
at least one contact condition includes an attribute corresponding to the quantity of successful sales by the agent and the post-contact behaviors include notifying the agent.

11. A method, comprising:
performing a predictive dialing campaign, the predictive dialing campaign being associated with a list of prospective contacts;
processing each of the prospective contacts in a desired sequence during said performing;
during said processing, evaluating a contact policy for each one of the prospective contacts as the one of the prospective contacts is being processed, the contact policy being responsive to one or more conditions corresponding to the one of the prospective contacts to select between at least two different processing behaviors;
determining one or more campaign characteristics as a function of said processing of several of the prospective contacts; and
during said performing, executing a campaign rule to adjust said performing, the campaign rule being responsive to at least one of the campaign characteristics to select between at least two different actions.

12. The method of claim 11, wherein the contact policy is one of a pre-contact type, contact analysis type, and post-contact type.

13. The method of claim 12, wherein the contact policy is of the contact analysis type, and said evaluating includes selecting between connecting an answered call to an agent, sending a fax, and transmitting a recording in response to the one or more conditions.

14. The method of claim 12, wherein the contact policy is of the pre-contact type, and the processing behaviors include rerouting the one of the prospective contacts.

15. The method of claim 12, wherein the contact policy is of the post-contact type and the processing behaviors include sending an email.

16. The method of claim 11, wherein the one of the processing behaviors includes connecting an answered call to one of a plurality of agents with an ACD.

17. The method of claim 11, wherein one of the processing behaviors includes connecting an answered call to an IVR.

18. A system, comprising: one or more servers operable to perform a predictive contact campaign, said one or more servers including: means for processing each of a number of prospective contacts in a sequence, said processing means including:
means for evaluating a contact policy for each one of the prospective contacts being processed, the contact policy being responsive to one or more conditions corresponding to the one of the prospective contacts to select between at least two different processing behaviors;
means for determining one or more campaign characteristics as a function of processing several prospective contacts; and
means for executing a campaign rule to adjust performance of the predictive contact campaign, the campaign rule being responsive to at least one of the campaign characteristics to select between at least two different actions.

19. A method, comprising:
operating a multisite server arrangement including a coordinating server coupled to one or more other servers by a wide area computer network, the coordinating server and two or more other servers each being associated with one of at least two contact centers remotely located relative to one another;
performing at least two contact campaigns of a workflow with the multisite server arrangement, said performing including each of the two or more other servers automatically placing calls with a predictive dialer;
controlling the workflow with the coordinating server, said controlling including directing collection of performance statistics; and
reviewing the performance statistics of one of the two or more servers from another of the two or more servers.

20. A system, comprising: a multisite server arrangement including a coordinating server coupled to one or more other servers by a wide area computer network, the coordinating server and two or more other servers each being associated with one of at least two contact centers remotely located relative to one another, the multisite server arrangement including:
means for performing multiple campaigns, said performing means including each of the two or more other servers automatically placing calls with a corresponding predictive dialer;
means for controlling the workflow with the coordinating server including means for collecting performance statistics; and
means for reviewing the performance statistics of one of the two or more servers from another of the two or more servers.

21. A method, comprising:
automatically dialing a telephone number with a predictive dialer to place a call from a contact center;
if the call is answered by a person, connecting the call to an agent at the contact center;
if the call is answered by a facsimile machine, sending a facsimile to the facsimile machine from the contact center; and
if the call is answered by a voice recording machine, transmitting a recorded message to the voice recording machine from the contact center.

22. The method of claim 21, which includes directing the call to an IVR before said connecting the call to the agent if the call is answered by a person.

23. The method of claim 21, wherein said connecting includes distributing the call to the agent with an ACD.

24. The method of claim 21, wherein a server includes logic defining the predictive dialer and the logic is further effective to selectively define one or more contact policies each being one of a pre-contact type, contact analysis type, and post-contact type.

25. The method of claim 21, wherein a server includes the predictive dialer and belongs to a multisite server arrangement configured to perform one or more campaigns of a workflow.

26. The method of claim 21, which includes predictively dialing another telephone number with the predictive dialer as a function of a number of different stages of a conversation between an agent and the person during the call.

27. The method of claim 21, which includes sending an email to the person if the call is not answered.
